(19) United States
(12) Patent Application Publication
(10) Pub. No.: US 2003/0018521 A1
(43) Pub. Date: Jan. 23, 2003

(54) Advertising based upon events reported from a GPS enabled event report system

(75) Inventors: Reiner Kraft, Gilroy, CA (US); Daniel Alexander Ford, Los Gatos, CA (US); Norman Jerome Pass, Sunnyvale, CA (US)

Correspondence Address: LACASSE & ASSOCIATES, LLC, 1725 DUKE STREET, SUITE 650, ALEXANDRIA, VA, 22314, US

(73) Assignee: INTERNATIONAL BUSINESS MACHINES CORPORATION

(21) Appl. No.: 09/905,885

(22) Filed: Jul. 17, 2001

(51) Int. Cl. G06F 17/60; H04M 3/42

(52) U.S. Cl. 705/14; 455/414

(57) ABSTRACT

Internet technologies, location tracking systems, and wireless handheld devices are integrated to target advertisement content to users based upon their interest in events in particular locations. Thus, advertisements are matched to correspond to real world events (i.e., traffic jams, weather events, etc.). Furthermore, event reporters who report information regarding new events are given a cut of the revenue generated by advertisements based upon how many other subscribers request and view the information reported by them.

### BACKGROUND OF THE INVENTION

1. Field of Invention

The present invention relates generally to the field of electronic advertising. More specifically, the present invention is related to targeting advertisements based upon a matching of events to subscribers based on location.

2. Discussion of Prior Art

There has been an increase in Internet based services and e-commerce applications. Hence, advertising is being diverted from conventional media channels (e.g., TV and radio) into Internet based communication channels (banner ads, etc.). There are also huge ongoing efforts to personalize this advertising to make it more effective.

The matching or “placement” of advertising with appropriate “host” material is a tedious procedure. Companies conduct marketing studies, perform surveys, analyze, and research various media channels in order to determine the best placement for their ads. An important goal is to target advertising to people who might be interested in the offered goods or services. However, another important goal is to reach as many people as possible. For instance, advertising during the super bowl in the U.S. attracts millions of sport enthusiastic viewers. Placing advertising here guarantees a high visibility.

In general, it's the interesting content provided by a service or content provider, which attracts people to consume or view this content. Therefore, dull content with no interest will attract no users. Interest and curiosity are motivators for people to engage in reading a particular article, watch a show on TV, etc. Furthermore, people are very curious about news and events that are happening around them. This curiosity of people is one of the reasons that they subscribe to the local newspaper. People in general are curious about new events, especially events with a high “shock” rate (e.g., accidents, crimes, unusual, etc.). Advertisers, who embed their message into delivery mediums such as television, radio, etc, exploit this curiosity factor. Thus, if an event has a high “shock” rate, many people will seek it out, and thus advertising associated with it will have a high visibility and coverage.

To facilitate the targeting of advertising, it would be beneficial to have an automatic event reporting system that:

a) updates event related information with newly received event information, and

b) transmits event related information to subscribers requesting such information along with appropriate advertisements.

The prior art systems given below describe, in general, how information is handled (received and transmitted) in hand-held computer-based systems, but none of these systems teach a targeted advertisement model used in conjunction with a hand-held system.

J. Spohrer's paper entitled, “Information in Places” provides for a comprehensive review regarding prior art wireless communication systems that are integrated with global positioning systems (GPS). The paper describes existing hand-held systems that associate electronic information with physical objects in an environment. These physical objects anchor the electronic information, providing hot spots and retrieval cues for the user.

In one prior art system mentioned in the paper, a mobile cellular phone is integrated with a GPS receiver and the phone includes a means for displaying maps. For example, user A of this specific system is able to call user B (who also utilizes a similar cellular phone) and view the location of B (relative to A's current location) on a displayed map.

Yet another prior art system described in this paper provides for a hand held device (3Com® Corporation's Palm Pilot®) that is integrated with a GPS receiver. The integrated device downloads multiple maps and routing directions from an online server, thereby able to guide clients in the instance they are lost.

Although many prior art systems are described in Spohrer's paper, none of them provide for a mobile event reporting system, integrated with a GPS receiver, that facilitates the real time entry of real world events by subscribers. Furthermore, none of the systems described in the paper integrate emerging mobile electronic devices with GPS-based position determination systems to target advertising content to subscribers based upon their interest in events in particular locations.

Whatever the precise merits, features and advantages of the above mentioned prior art systems, none of them achieve or fulfills the purposes of the present invention.

### SUMMARY OF THE INVENTION

The present invention provides for a system and method for matching and transmitting advertisements with event related information, wherein the event related information is dynamically updated based upon inputs related to information regarding new events. Therefore, the present invention provides for a system and method for:

subscriber-based updating of stored event information upon receiving new event information,

matching advertisements to said updated event information, and

transmitting said updated event information and matched advertisements to one or more subscribers requesting such information.

In an extended embodiment, the present invention calculates the distance between each of the subscribers and their respective identified events of interest and filters only events that fall within a threshold radius.

In yet another embodiment, the present invention provides for a business method for providing subscribers, who report event related information, with financial benefits based upon the extent of utilization, by other subscribers, of such reported information. Event reporters get a percentage of the profit generated by advertisements accompanying such event related information. Thus, if subscriber A reports one or more events and these reported events happen to be of interest to other subscribers, then subscriber A is given a cut of the advertisement revenues based on whether other subscribers view these reported events. In an extended embodiment, the reported event information is used to generate revenue by selling, over a network such as the Internet, such information to other content providers.

Furthermore, in the preferred embodiment, the integrated electronic device provides for a “radar” screen graphical user interface (GUI) that displays events that are relevant to a subscriber utilizing the device. In this embodiment, the GUI displays a map of the surrounding area based on a detected current location and the subscriber's position is marked and centered on the display. Additionally, all events related to the subscriber that fall within a preset threshold radius are displayed on the map around the marked position. In an extended embodiment, the events are displayed on the GUI screen as icons. Subscribers are then able to click on the icon and get more information regarding the event.

In another embodiment, events of interest to a subscriber are displayed on the graphical user interface for only a predetermined period of time or for only a predetermined threshold of time. In this instance, the events are purged from the display after the threshold of time is reached.

Additionally, other embodiments are envisioned wherein inputs to the integrated electronic device associated with each of the embodiments described above are any of, but not limited to, the following: touch screen input, keyboard input, voice input, pen or stylus input.

### BRIEF DESCRIPTION OF THE DRAWINGS

FIG. 1 illustrates a block diagram of the preferred embodiment of the system of the present invention.

FIG. 2 illustrates a sample subscriber location record that is stored in location database in FIG. 1.

FIG. 3 illustrates an example of a profile record stored in the profile database in Figure FIG. 4 illustrates an example of a status record stored in the status database in FIG. 1.

FIG. 5 illustrates a flow chart associated with the method of the present invention.

### DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

It should be noted that the terms, “user(s)” and “subscriber(s)”, as used throughout the specification are equivalent, and can thus be used interchangeably. Thus, the use of subscriber(s) in place of/over user(s) should not unduly place limits on the scope of the present invention.

The present invention provides for an automatic real world event (accidents, street anomalies, natural disasters, etc.) reporting system, wherein subscribers of the system are able to participate actively in the event reporting system. This is accomplished via an electronic device, which enables convenient reporting of these events. Examples of electronic devices include, but are not limited to, personal digital assistants (PDAs), mobile computers, hand-held computer-based devices, mobile phones, cellular phones, and pagers. Thus, participants of this system serve the function of “event reporters”. In the preferred embodiment, the electronic device has integrated location-tracking functionality, which allows it to automatically report an event and it's location. Furthermore, a graphical user interface (GUI) is provided to allow for modifying the current event location, in case the event happens at a distance from the event reporter. For example, a person witnessing a tornado unfolding at a distance of 1 mile would press a “tornado” button (or dial a short numeric sequence) on a wireless PDA, along with a direction vector for the relative coordinates. This event would then be sent to a central event location processing server.

Subscribers of the event reporting system have a graphical display, showing a visual representation of specific subscribed events. In the preferred embodiment, a “radar screen” GUI is used, showing the current location of a subscriber in the center, and all subscribed events (“hot spots”) currently happening around this location. In another extended embodiment, events are represented using icons (visual representation) for different event categories. For instance a car accident could be represented using a blinking representation of a damaged car, etc. A more detailed description of the system architecture is provided later.

Thus, the event reporting system of the present invention facilitates easy entry of real world events. Furthermore, the event reporting system infrastructure, when used in conjunction with advertisement methods, provides various financial benefits.

To illustrate the present invention, consider the case where an accident happens 1 mile ahead of a subscriber comminuting to work. As soon as this event (accident) is reported it is displayed on the subscriber's radar screen. Furthermore, if the reported event is

a) a car accident or

b) it's close to the subscriber's current physical location,

the likelihood that subscribers want to know more about this event is high if they are in the vicinity of the accident. In the preferred embodiment, the interface associated with the present invention is similar to a web browser, wherein subscribers are able to click on events to get information pertaining to such events. Furthermore, information displayed regarding events comprises both detailed event information (e.g., picture, text) and an advertisement.

Thus, on one hand, advertisers benefit from the high page views that recorded events produce, and on the other hand, subscribers of such an event reporting system are better informed about events happening around them. Since subscribers are actively participating and providing event information in real time, a variety of events are reported to the system, which in turn are displayed on electronic devices associated with other subscribers who are in need of this information. In such a system, as the number of subscribers utilizing the present invention increases, the probability associated with the number of reported events also increases. Furthermore, in the preferred embodiment, a rating mechanism is used wherein event observers are able to rate the quality of the event entry, thereby fostering competition for the best event reporter.

In yet another embodiment, a monetary reward is provided to motivate subscribers to enter new events. For instance, upon providing the system with event information, the subscriber who reported the event is able to get a cut on the advertising revenues based on how many other subscribers view the provided information. In an extended embodiment, these reported events are made available on the web, and sold to content providers, who in turn utilize them to generate additional revenue.

Overall, the invention presents a novel framework for reporting events, and introduces opportunities for advertisers to cover and reach a broad audience. Thus, the invention provides for a valuable marketing instrument that is used in conjunction with emerging e-commerce applications.

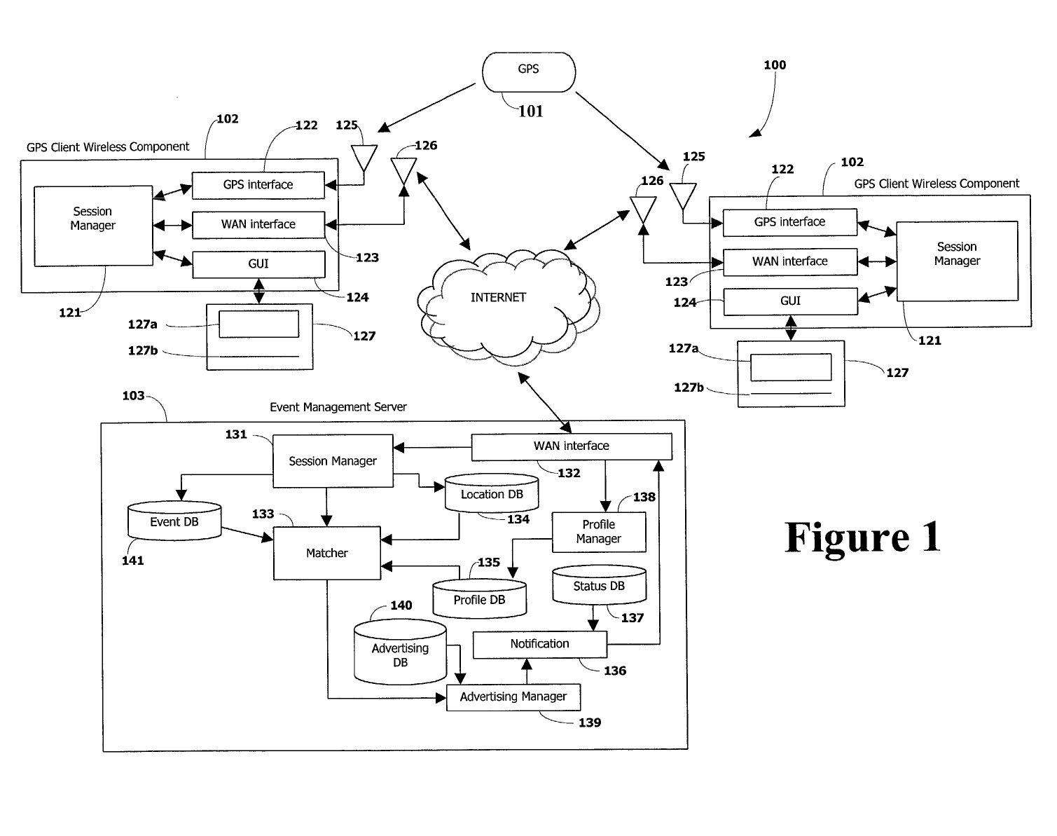

FIG. 1 shows a block diagram of the system. The system includes two main components:

1. GPS client wireless component (102)

2. Event Management Server (103)

Each of these main components comprise the following sub-components (also see FIG. 1), listed below:

GPS 101

GPS Client Wireless Component 102

Session Manager 121

GPS Interface 122

WAN Interface 123

GUI 124

GPS Antenna 125

WAN Transceiver Antenna 126

I/O Device 127

Event Management Server 103

Session Manager 131

WAN Interface 132

Matcher 133

Location database 134

Profile database 135

Notification 136

Status database 137

Advertising Manager 139

Profile Manager 138

Advertising database 140

Event database 141

A detailed description of the above listed system components are described below:

GPS 101 refers to existing global positioning systems and satellite-based position determination systems. GPS technology is used for determining the position of both real world events and subscribers.

1. GPS Client Wireless Component

In the preferred embodiment, GPS Client Wireless Component (CWC) 102 is implemented within a laptop computer, cell phone, personal digital assistant (PDA), or integrated in a car system having a wireless wide area network (WAN) connection 123 for communicating with event management server 103. It should be noted that although specific examples of client wireless components are provided for the purposes of illustrating the preferred embodiment, one skilled in the art can envision other electronic devices without departing from the scope of the present invention.

In the preferred embodiment, CWC includes a GPS interface 122 for receiving location information. Tasks of CWC 102 include identifying the location of subscribers and sending this information to event management server 103. In addition, the CWC receives data from event management server 103 and displays it for the subscriber on display device 127a.

GPS client wireless component 102 operates under the control of the respective session Manager 121. Session manager 121 is responsible for the interaction between various sub-components of the CWC. It prepares the incoming data, such as location and data to send them either to event management server 103 over WAN interface 123 or displays them over GUI 124 on screen 127a.

In one embodiment, GPS Interface 122 is implemented as a miniaturized GPS receiver that measures the time a radio signal needs to travel from a GPS satellite in GPS system 101, until it arrives at GPS antenna 125. By knowing the speed of the radio signal (which is approximately the speed of light), and when each signal is transmitted, the distance to one or more satellites is determined. The final solution of the equations (described later in the specification) produces an exact position of antenna 125 (latitude, longitude). GPS receiver interface 122 determines a current location associated with GPS client wireless component 102 and supplies the current location to session manager 121. WAN interface 123 supports a wireless connection to a network such as the Internet. Interface 123 helps GPS client wireless component 102 to remain connected to the event management server 103.

Graphic user interface (GUI) 124 is implemented in GPS client wireless component 102 for an easy-way to configure and administrate. Interface 124 is implemented using buttons that are mapped to predefined events (e.g., tornado button), or alternatively, subscribers are able to choose an event from within a list of common events. In the preferred embodiment, the event position is reported by marking the specific event location on a displayed map of the surrounding area. In addition, an event may be static or moving.

GPS antenna 125 connects to GPS interface 122 to receive GPS data from the GPS satellite system.

WAN transceiver antenna 126 provides for a wireless connection to a network such as the Internet. It is connected to WAN interface 123 of GPS client wireless component 102.

In one embodiment, output device 127a is implemented as a display of a wireless device and input device 127b as a touch screen. In this instance, the touch screen is used for both receiving manually user inputs and for configuration purposes. Furthermore, the display provides for a means for outputting messages.

2. Event Management Server

Event management server 103 receives the current physical location from connected subscribers. In addition, it receives reported events. Event management server 103 further processes these events. A matching process is initiated in the event management server to associate one or more advertisements to a specific event. Any identified advertisements are then broadcast to subscribers of the specific event.

Subscribers are usually interested in an event that happens in a close surrounding. Thus, in one embodiment, subscribers of the system of the present invention are able to set a threshold for displaying events. For example, a subscriber is able to set a threshold of 1 mile, and thereby instructing the system to display only those subscribed events that are within a 1 mile radius. In another embodiment, subscribers are able to filter out particular events of no interest to them. Furthermore, for events that have advertisements associated with them, event management server 103 sends out the advertisement message along with event information to subscribers of that event. In one embodiment, the advertising message is represented as an icon, which the subscriber then selects to get more details.

Wide area network (WAN) interface 132 supports the connection to the Internet for the communication/interaction between server 103 and GPS client wireless component 102.

Session manager 131 gets the location information of subscribers over WAN interface 132. Then, session manager 131 stores this information in location database 135 and notifies matcher 133 of the new subscriber's location by sending a ‘User ID’. It also receives newly reported events from subscribers, and stores these into the event database 140. In the preferred embodiments, events comprise any of: an event name, an event category, event location (approximate), or event type (static or dynamic) along with additional useful event attributes. It should be noted that although specific attributes of events are used to illustrate the preferred embodiment, one skilled in the art can envision other event attributes (not mentioned in the specification) that can be transmitted (by subscribers) to the session manager 131 of the present invention's system. Thus, these specific event attributes should not be used to limit the scope of the present invention.

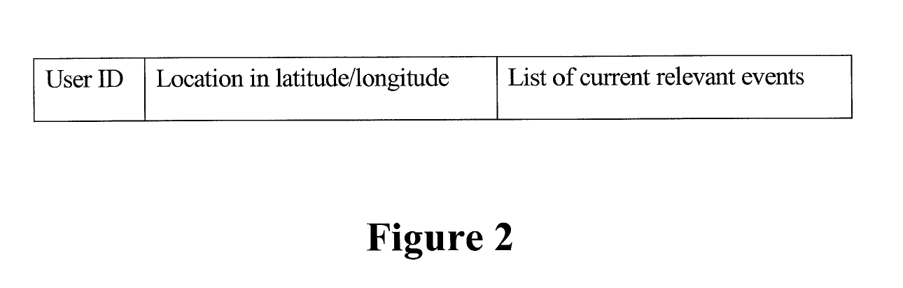

Location database 134, in the preferred embodiment, is implemented as a database that stores locations and a list of current relevant events. Stored locations associated with one or more subscribers are updated constantly in real time and stored events are also updated constantly based on inputs from subscribers. To account for the mobility of subscribers and the highly dynamic nature of events, location database 134 is implemented efficiently for fast access and retrieval. For example, the subscriber location record that is stored in location database 134 has the format shown in FIG. 2.

As mentioned earlier, session manager 131 associated with the event management server updates the location records.

Event database 140 is implemented as a database to store the current locations of reported events. In one embodiment, events have a defined time to live, before they will be purged. Furthermore, there exists the possibility that several different subscribers report the same event simultaneously. In this scenario, an event management process detects similar events and merges these into one event. Additionally, as one or more events become obsolete, the event management process deletes those events.

Matcher 133 starts out by measuring the distance between a subscriber's location, and a reported event. When matcher 133 gets a notification from session manager 131 (when a new event was reported, an event moved, or the location of a subscriber changed), it measures the distance between the subscriber's new location and all other currently active and relevant events from event database 141. Relevant events in this context are events of interest for the subscriber (a detailed description of relevant events are outlined with regard to the profile database 135 described below). Matcher 133 performs a computation of the distance (an algorithm used in conjunction with this invention for computing the distance between two points, given the latitude and longitude, is described later in the specification) only for events that are relevant to subscribers. When the measured distance is less than some profile specific threshold, matcher 133 triggers notification component 136 to send a message to the subscriber. A client side electronic device then represents the event using a GUI. For example, the electronic device displays a map of the surrounding area in a GUI and relevant events are represented in the GUI as little icons. In other embodiments, standard profile matching techniques are used to implement a highly efficient matching process.

Profile database 135 contains information regarding which type of events a subscriber is interested in (e.g., event categories), and the proximity of the event category, which will trigger a notification for this subscriber. Thus, the threshold is associated with the event itself. Furthermore, it contains a user-defined threshold for each relevant event itself. As an example the “tornado” event category might have a threshold of 10 miles, which is associated directly to the event. In addition, advertising preferences, preferred GUI settings etc., can be stored in each subscriber's profile.

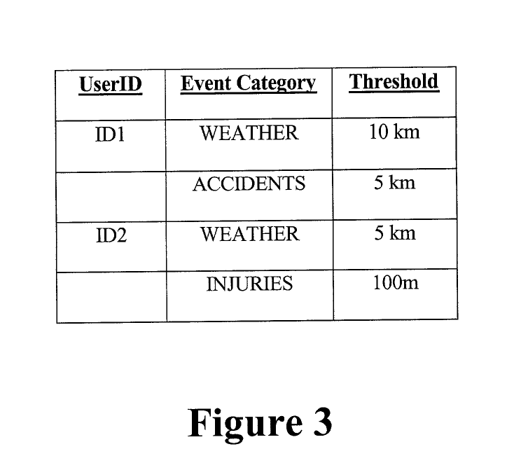

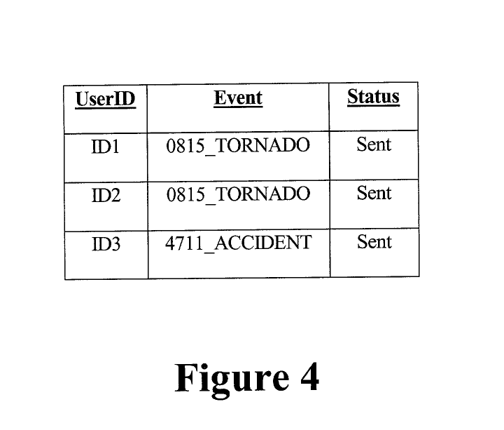

The matcher 133 needs this information to decide whether to inform the subscriber of a new event or not. An example of a profile record is illustrated in the table shown in FIG. 3.

Matcher 133 triggers notification component 136. Before notification component 136 sends a notification to a subscriber, it makes sure that the proximity of an event has not been already sent to the subscriber. Thus, notification component 136 requests the status of a subscriber from status database 137 and performs a check to see if that subscriber already has the specific event information. It should be noted that the notification message for each subscriber contains a list of events, which can be represented on the client device depending on its capabilities. For example, a PDA such as the MS® Pocket PC® is able to represent a nice map of the surrounding area, using graphical symbols to represent icons. On the other hand, a cell phone is able to use a text message to represent an event.

Status database 137 contains subscriber specific information regarding whether or not the proximity of a specific event has already been sent to a subscriber (who lists this event as being relevant) or not. As mentioned earlier, notification component 136 needs this information for avoiding sending the same reported event to the same subscriber several times. An example of a status record is shown in FIG. 4.

Profile manager component 138 manages the profile database 135 as it updates records for subscribers. In one embodiment, subscribers are able to set their profile over a network, such as the Internet, with their client device.

As mentioned earlier, the event reporting system infrastructure is used in conjunction with advertisement methods to provide a revenue generating means. Advertising manager 139 receives a notification of a new event from the matcher 133. Advertising manager 139 then looks up whether there's an appropriate advertising message to associate with the new event. In the instance that an advertising message exists, an association is made between this message and the new event. Then, this message, along with the new event, is sent to notification 136 component for further processing. Advertising messages are stored in advertising database 140. In an extended embodiment, advertising manager 139 stores statistics regarding the advertising usage, which can then be used for accounting purposes. In other embodiments, depending on the way a business is performed, specific business logic is defined and integrated into the advertisement manager.

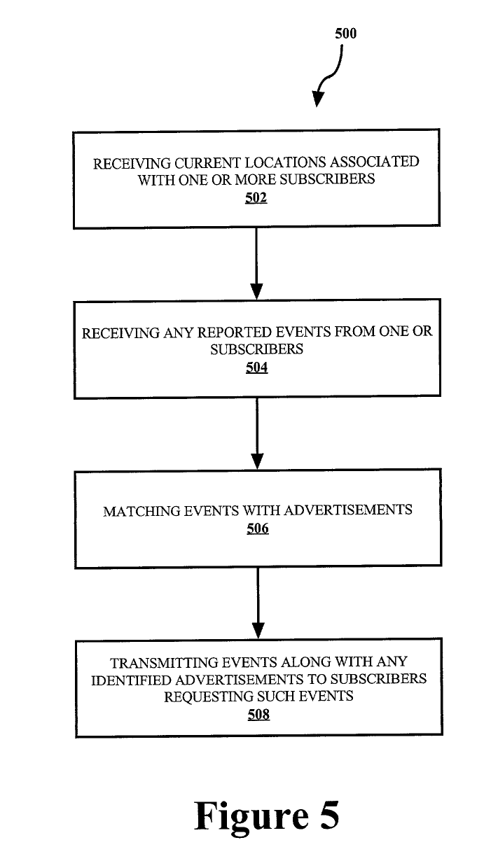

FIG. 5 illustrates a general overview of method 500 associated with the system described in FIG. 1. First, current locations associated with one or more subscribers are received 502. Furthermore, any reported events are also received from subscribers 504. Next, a matching process is initiated that associates events with advertisements 506. Lastly, events along with any identified advertisements are transmitted to subscribers of such events 508.

It should be noted that the calculation of distance between subscribers and events is necessary for the implementation of the system and method of the present invention. Thus, given a latitude (La₁) and longitude (Lo₁) associated with a first position, and a latitude (La₂) and longitude (Lo₂) associated with a second position, the distance in kilometers between the two positions is given by:

Distance 1.852×0.6×αcos [sin(La₁)×sin(La₂)+cos(La₁)×cos(La₂)×cos(Lo₂−Lo₁)]

Furthermore, the present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM or any other appropriate static or dynamic memory, or data storage devices.

Implemented in computer program code based products are software modules for receiving a current location associated with one or more subscribers, receiving reported events from one or more subscribers, matching reported events with advertisements, and transmitting events with advertisements to subscribers such events.

### Conclusion

A system and method has been shown in the above embodiments for the effective implementation of a system and method for advertising based upon events reported from a GPS enabled event report system. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, or specific computing hardware. Furthermore, specific examples of client wireless components, profile matching techniques, event attributes, and entries in user location record are used to illustrate the various embodiments associated with the present invention and, hence, should not be used to limit the scope of the present invention.

The above enhancements and described functional elements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of global positioning systems and wireless communications.

1. A method for updating stored event information based upon received new event information, said method further matching advertisements to said updated event information, and transmitting said updated event information and matched advertisements to one or more subscribers, said method comprising the steps of:
a. receiving current physical location associated with one or more members of a set of subscribers;
b. receiving information reported on one or more events from a subset of said set of subscribers;
c. updating stored event information based upon information reported;
d. identifying events of interest to one more members of said set of subscribers from said updated stored event information;
e. matching one or more advertisements from a set of stored advertisements with each of said identified events of interest;
f. calculating distance, based upon said received current physical location, between each member of said set of subscribers and their respective identified events of interest and filtering only events that fall within a threshold radius, and
g. transmitting to each of said set of subscribers said identified event information that fall within said threshold radius along with corresponding matched advertisements.

2. A method for updating stored event information based upon received new event information, as per claim 1, wherein said method further comprises the step of purging events among said stored events after a predetermined time period.

3. A method for updating stored event information based upon received new event information, as per claim 1, wherein said method further comprises the step of rewarding said subset of subscribers if their reported information is transmitted to other members.

4. A method for updating stored event information based upon received new event information, as per claim 1, wherein said transmission is done via any of the following: an e-mail message, SMS message, markup language document, or XML document.

5. A method for updating stored event information based upon received new event information, as per claim 1, wherein said method further comprises the step of filtering only events that match a profile associated with a member.

6. A method for updating stored event information based upon received new event information, as per claim 1, wherein said method further comprises the step of checking a status associated with subscribers, said status identifying if a prior transmission occurred regarding s aid events that fall within said threshold, and if such a transmission occurred, said method terminating said transmission step thereby avoiding re-transmitting said events that fall within said threshold.

7. A method for updating stored event information based upon received new event information, as per claim 1, wherein said method further comprises calculating accounting statistics related to said transmitted advertisements.

8. A method for updating stored event information based upon received new event information, as per claim 1, wherein said step of calculating distance between each member and their respective identified events of interest is calculated using:
1.852×0.6×αcos [sin(La₁)×sin(La₂)+cos(La₁)×cos(La₂)×cos(Lo₂−Lo₁)],
where La₁ and Lo₁ are the latitude and longitude associated with said subscriber and La₂ and Lo₂ are the latitude and longitude associated with said identified event of interest.

9. A real time event reporting system, said system comprising:
a. one or more databases storing any of, or a combination of, the following: received real time location information associated with members of a set of subscribers, event information related to one or more events, profiles associated with each of said members, status information related to said members, and a set of advertisements;
b. a session manager receiving said real time location information and reported event information and updating such information in said databases;
c. a matcher identifying events of interest for each of said members and calculating distances between said identified events and corresponding member;
d. an advertising manager matching advertisements in said databases with said identified events of interest for each of said member, and
e. a notification component transmitting, to each of said set of subscribers, said events of interest and corresponding matched advertisements.

10. A real time event reporting system, as per claim 9, wherein said one or more databases comprise any of, or a combination of, the following: a location database storing said real time location information, an event database storing said information related to one or more events, a profile database storing said profiles associated with members, and an advertisement database storing said set of advertisements.

11. A real time event reporting system, as per claim 9, wherein said system further comprises a status checker for identifying if a prior transmission occurred regarding said events of interest, and if such a transmission occurred, said status checker terminating said transmission, thereby avoiding re-transmitting said events of interest.

12. A real time event reporting system, as per claim 9, wherein said event information is any of the following: an event name, an event category, an event location, or event type.

13. A real time event reporting system, as per claim 12, wherein said event type is either static or dynamic.

14. A real time event reporting system, as per claim 9, wherein said transmission of events of interest is done via any of the following: an e-mail message, a SMS message, a markup language document, or XML document.

15. A real time event reporting system, as per claim 9, wherein said transmission is received in one of the following devices: a hand-held device, personal digital assistant (PDA), mobile telephone, or mobile computer.

16. A business method for providing subscribers reporting event related information with financial benefits based upon the utilization of said reported event related information, said method comprising the steps of:
a. receiving new information related to each of one or more events from one or more event reporters, said event reporters forming a subset among a set of subscribers;
b. updating a storage space containing event related information with said received new information;
c. matching said received new information with advertisements in said storage space;
d. accessing profiles associated with said subscribers and identifying subscribers requesting said received new information;
e. transmitting to each of said identified subscribers said requested received new information and said matching advertisements, and
f. paying an event reporter a percentage of revenue generated via advertisements if information reported by said event reporter is transmitted to one or more subscribers requesting said information.

17. A business method for providing subscribers reporting event related information with financial benefits based upon the utilization of said reported event related information, as per claim 16, wherein said method further comprises the step of a calculating distance between each of said subscribers and events associated with their request and filtering only events that fall within a threshold radius.

18. A business method for providing subscribers reporting event related information with financial benefits based upon the utilization of said reported event related information, as per claim 16, wherein said subscribers are charged a subscription fee for accessing said stored event related information.

19. A business method for providing subscribers reporting event related information with financial benefits based upon the utilization of said reported event related information, as per claim 16, wherein additional revenue is generated based upon a transference of said stored information related to one or more events to other content providers, said transference done over a network.

20. A business method for providing subscribers reporting event related information with financial benefits based upon the utilization of said reported event related information, as per claim 19, wherein said network is any of the following: local area networks (LAN), wide area networks (WAN), HTTP-based networks, wireless networks, or the Internet.

21. An article of manufacture comprising a usable medium having computer readable program code embodied therein which updates stored event information based upon received new event information, said computer readable program code further matching advertisements to said updated event information, and transmitting said updated event information and matched advertisements to one or more subscribers, said medium further comprising:
a. computer readable program code receiving current physical location associated with one or more members of a set of subscribers;
b. computer readable program code receiving information reported on one or more events from a subset of said set of subscribers;
c. computer readable program code updating stored event information based upon information reported;
d. computer readable program code identifying events of interest to one more members of said set of subscribers from said updated stored event information;
e. computer readable program code matching one or more advertisements from a set of stored advertisements with each of said identified events of interest;
f. computer readable program code calculating distance, based upon said received current physical location, between each member of said set of subscribers and their respective identified events of interest and filtering only events that fall within a threshold radius, and
g. computer readable program code transmitting to each of said set of subscribers said identified event information that fall within said threshold radius along with corresponding matched advertisements.

22. An e-commerce model for matching and transmitting advertisements to subscribers, said model comprising:
a. one or more databases storing information related to one or more events, said stored information dynamically updated with information related to new events based upon inputs from event reporters, said event reporters forming a subset among said subscribers;
b. an advertisement manager matching said stored information related to events with one or more advertisements, said advertisements generating revenue based upon subscribers viewing said advertisements, and
c. a transmitter transmitting to said subscribers said matched stored information related to events and corresponding advertisements over a network.

23. An e-commerce model for matching and transmitting advertisements to subscribers, as per claim 22, said model further comprises a notifier providing said event reporters with a cut of said generated revenue if their inputs regarding information related to new events are transmitted to said subscribers.

24. An e-commerce model for matching and transmitting advertisements to subscribers, as per claim 22, wherein additional revenue is generated based upon a transference of said stored information related to one or more events to other content providers, said transference done over said network.

25. An e-commerce model for matching and transmitting advertisements to subscribers, as per claim 22, wherein said subscribers are charged a subscription fee to access said stored information related to one or more events.

26. An e-commerce model for matching and transmitting advertisements to subscribers, as per claim 22, wherein said network is any of the following: local area networks (LAN), wide area networks (WAN), HTTP-based networks, wireless networks, or the Internet.
